(19) United States
(12) Patent Application Publication
(10) Pub. No.: US 2025/0229256 A1
(43) Pub. Date: Jul. 17, 2025

(54) EXHAUST GAS PURIFYING CATALYST

(71) Applicant: TOYOTA JIDOSHA KABUSHIKI KAISHA, Toyota-shi (JP)

(72) Inventors: Hiroyuki ISHIKAWA, Anjo-shi (JP); Hiroki SHIRAKAWA, Seto-shi (JP)

(73) Assignee: TOYOTA JIDOSHA KABUSHIKI KAISHA, Toyota-shi (JP)

(21) Appl. No.: 18/951,095

(22) Filed: Nov. 18, 2024

(30) Foreign Application Priority Data
Jan. 17, 2024 (JP) 2024-005060
Jun. 12, 2024 (JP) 2024-095196

(51) Int. Cl. B01J 23/46; B01J 21/06; B01J 23/20

(52) U.S. Cl. CPC B01J 23/464; B01J 21/066; B01J 23/20; B01J 2523/48; B01J 2523/56; B01J 2523/822

(57) ABSTRACT

[Summary]

[Problem]

An exhaust gas purifying catalyst, in particular a three-way catalyst, with improved catalytic activity is provided.

[Solution]

The exhaust gas purifying catalyst of the present disclosure is an exhaust gas purifying catalyst comprising rhodium particles, zirconium dioxide particles, which are rhodium particles, zirconium dioxide particles doped with cations having an oxidation number higher than that of zirconium, and carrier particles, wherein the rhodium particles are supported on the zirconium dioxide particles, and (i) the carrier particles are porous carrier particles, and the rhodium particles and the zirconium dioxide particles are supported in pores of the porous carrier particles, or (ii) the carrier particles are composed of a plurality of primary particles, and the rhodium particles and the zirconium dioxide particles are dispersed inside the carrier particles.

### TECHNICAL FIELD

The present disclosure relates to an exhaust gas purifying catalyst.

### BACKGROUND OF THE INVENTION

The present invention relates to a catalyst for purifying an exhaust gas containing a noble metal; alumina support particles; and ZrO₂ semiconducting particles supported on the surface of the alumina support particles.

Patent Document 2 discloses an exhaust gas purification catalyst comprising at least one noble metal selected from the group of Pt, Pd, Rh and a composite compound in which a compound of at least one metal element selected from the group of Al, Ce, La, Zr, Co, Mn, Fe, Mg, Ba, Ti is substantially uniformly dispersed in at least one oxide selected from the group of Al₂O₃, ZrO₂, CeO₂, wherein a part of the surface area of the noble metal is coated with the composite compound, and the noble metal is supported on the composite compound.

### PRIOR ART DOCUMENTS

### Patent Document

### [Patent Document 1]

WO2020/050464 A1

### [Patent Document 2]

JP 2006-198594 A

### SUMMARY OF THE INVENTION

### Problem to be Solved by the Invention

There is a need to improve the catalytic activity of exhaust gas purifying catalysts, particularly three-way catalysts.

### Means for Solving the Problem

The inventors of the present disclosure have found that the above problem can be achieved by the following means:

### Embodiment 1

Exhaust gas purifying catalyst comprising of rhodium particles, zirconium dioxide particles doped with cationics having a higher number of oxides than zirconium, and carrier particle, wherein
the rhodium particles are supported on the zirconium dioxide particles, and
(i) the carrier particles are porous carrier particles, and the rhodium particles and the zirconium dioxide particles are supported in pores of the porous carrier particles, or
(ii) the carrier particles are composed of a plurality of primary particles, and the rhodium particles and the zirconium dioxide particles are dispersed inside the carrier particles.

### Embodiment 2

The exhaust gas purifying catalyst according to Embodiment 1, which satisfies (i) above.

### Embodiment 3

The exhaust gas purifying catalyst according to Embodiment 1, wherein the catalyst satisfies the above (ii).

### Embodiment 4

The catalyst for exhaust gas purification according to any one of aspects 1 to 3, wherein a ratio of a mass of the zirconium dioxide particles to a total mass of the zirconium dioxide particles and the porous support particles is 1.0 to 20.0% by mass.

### Embodiment 5

The exhaust gas purifying catalyst according to any one of embodiments 1 to 4, wherein the cation is niobium.

### Embodiment 6

The exhaust gas purifying catalyst according to Embodiment 5, wherein the content of niobium in the zirconium dioxide particles is 1.0 to 7.0 mass %.

### Embodiment 7

The exhaust gas purifying catalyst according to any one of embodiments 1 to 6, wherein the support particles are aluminum oxide.

### Effect of the Invention

According to the present disclosure, it is possible to provide the catalytic activity of an exhaust gas purifying catalyst having an improved catalytic activity, particularly a three-way catalyst.

### BRIEF DESCRIPTION OF THE DRAWINGS

FIG. 1

FIG. 1 is a schematic diagram of an exhaust gas purifying catalyst according to an embodiment of the present disclosure.

FIG. 2

It is a schematic view of an exhaust gas purifying catalyst according to another embodiment of the present disclosure.

FIG. 3

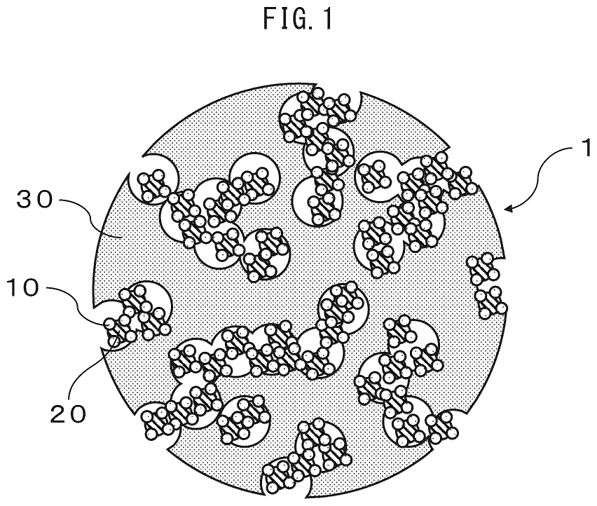

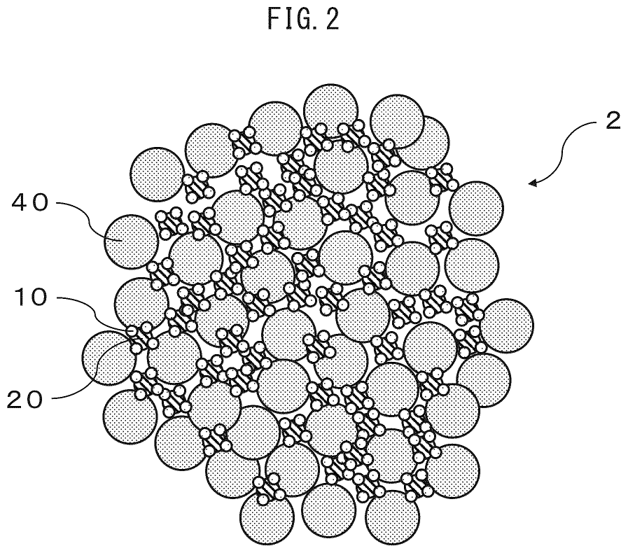

FIG. 1 is a graph showing the relation between the niobium content (% by weight) and the 50% purification temperature (° C.) of NOx in the samples of Examples 1 and 2 and Comparative Examples 1 to 3.

FIG. 4

It is a graph showing the relation between the mass percentage ratio of niobium to zirconium and 50% purification temperature of NOx (° C.) in Examples 1, 2, and 3 and Comparative Examples 1, 2, and 7.

### MODE FOR CARRYING OUT THE PRESENT INVENTION

Hereinafter, embodiments of the present disclosure will be described in detail. It should be noted that the present disclosure is not limited to the following embodiments, and various modifications can be made within the scope of the present disclosure.

### 1. Exhaust Gas Purifying Catalyst

The exhaust gas purifying catalyst of the present disclosure comprises rhodium particles, zirconium dioxide particles, and porous support particles doped with cationics having an oxidation number higher than that of zirconium. The rhodium particles are supported on zirconium dioxide particles. The rhodium particles and the zirconium dioxide particles are supported in the pores of the porous support particles. The exhaust gas purifying catalyst of the present disclosure may have, instead of the above, rhodium particles, zirconium dioxide particles, and zirconium dioxide particles doped with cationics having an oxidation number higher than that of zirconium, and support particles. The rhodium particles may be supported on the zirconium dioxide particles, and the rhodium particles and the zirconium dioxide particles may be dispersed within the carrier particles. Here, the carrier particles are secondary particles in which the primary particles constituting the carrier particles are aggregated, and the rhodium particles and the zirconium dioxide particles are disposed between the primary particles.

The exhaust gas purifying catalyst of the present disclosure may be a three-way catalyst.

In general, rhodium as a catalytic metal exhibits a higher catalytic activity, in particular with respect to NOx reduction, compared to palladium and platinum. By improving the catalytic activity of rhodium, it is expected to reduce the amount of rhodium used.

In this regard, the rate-limiting step in the reduction of NOx in the exhaust gas is CO₂ generating pathway. In other words, the reaction between the O atoms adsorbed on the rhodium particles and CO is rate-limiting. Therefore, if it is possible to lower the adsorption energy of O atoms adsorbed on rhodium particles, it is possible to improve the reduction performance of NOx of the exhaust gas purifying catalyst.

In the exhaust gas purifying catalyst of the present disclosure, rhodium particles are supported on zirconium dioxide particles. The zirconium dioxide particles are electron-rich because they are doped with cationics having a higher oxidation number than zirconium. The electrons flow into the rhodium particles to lower the adsorption energy of the O atoms. Therefore, the exhaust gas purifying catalyst of the present disclosure has a high reduction performance of NOx.

In addition, zirconium dioxide particles are particularly highly adsorbed among metal oxides, and are easily adsorbed with rhodium, for example, rhodium oxide (RhO₂). Among them, the zirconium dioxide particles doped with cationics, in particular niobium, have a particularly high adsorption energy compared to the zirconium dioxide particles not doped with cations. As a result, transpiration of rhodium is suppressed, and high heat resistance is realized.

In addition, in the exhaust gas purifying catalyst of the present disclosure, since the zirconium dioxide particles are supported in the pores of the porous support particles, aggregation of the zirconium dioxide particles is also suppressed, and thus the heat resistance is further improved. Rhodium particles are also supported on the zirconium dioxide particles and in the pores of the porous support particles. Alternatively, in the exhaust gas purifying catalyst of the present disclosure, since the zirconium dioxide particles are dispersed inside the support particles, aggregation of the zirconium dioxide particles is suppressed, and thus the heat resistance is further improved. The rhodium particles are also supported on the zirconium dioxide particles, and are supported inside the carrier particles.

That is, the exhaust gas purifying catalyst of the present disclosure achieves both high NOx reduction performance and high heat resistance.

The exhaust gas purifying catalyst may have a specific surface area after a durability test of 90 m2/g or less. Here, the durability test is performed by placing the exhaust gas purifying catalyst in a flow-through type durability furnace, and alternately and repeatedly flowing the reducing gas (CO) and the oxidizing gas (O₂) at 1000° C. for 5 hours.

The specific surface area after the durability test of the disclosed exhaust gas purifying catalyst may be 90 m²/g or less, 89.9 m²/g or less, 89.8 m²/g or less, or 89.7 m²/g or less, and may be 88.0 m²/g or more, 88.1 m²/g or more, 88.2 m²/g or more, or 88.3 m²/g or more.

NOx50% purifying temperature after the durability test of the disclosed exhaust gas purifying catalyst may be 250° C. or less. Here, NOx50% purification temperature is measured as follows. The exhaust gas purifying catalyst is placed in a flow-through reactor, heated to 500° C. at a heating rate of 50° C. per minute in a model gas for evaluation, held at this temperature for 10 minutes, and then lowered to 100° C. Thereafter, the temperature is heated at a heating rate of 20° C./min, and the temperature reached when the purification rate of NOx in the gases becomes 50% is calculated as NOx50% purification temperature. Model compositions for evaluation are CO (0.65 volume %, CO₂ (10.00 vol %), C₃H₆ (0.10 vol %), NO (0.15 volume %), O₂ (0.70 vol %), H₂ (3.00 vol %), and N₂ (residual).

NOx50% purification temperature after the durability test of the disclosed exhaust gas purifying catalyst may be 250° C. or less, 249° C. or less, 248° C. or less, 247° C. or less, or 246° C. or less, and may be 245° C. or more, 246° C. or more, 247° C. or more, or 248° C. or more.

FIG. 1 is a schematic diagram of an exhaust gas purifying catalyst according to an embodiment of the present disclosure.

As shown in FIG. 1, an exhaust gas purifying catalyst 1 according to an embodiment of the present disclosure includes rhodium particles 10, zirconium dioxide particles 20, and zirconium dioxide particles 20 doped with cationics having a higher oxidation number than zirconium, and porous support particles 30. The rhodium particles 10 are supported on the zirconium dioxide particles 20. The rhodium particles 10 and the zirconium dioxide particles 20 are supported in the pores of the porous support particles 30.

Note that FIG. 1 is not intended to limit the exhaust gas purifying catalyst of the present disclosure.

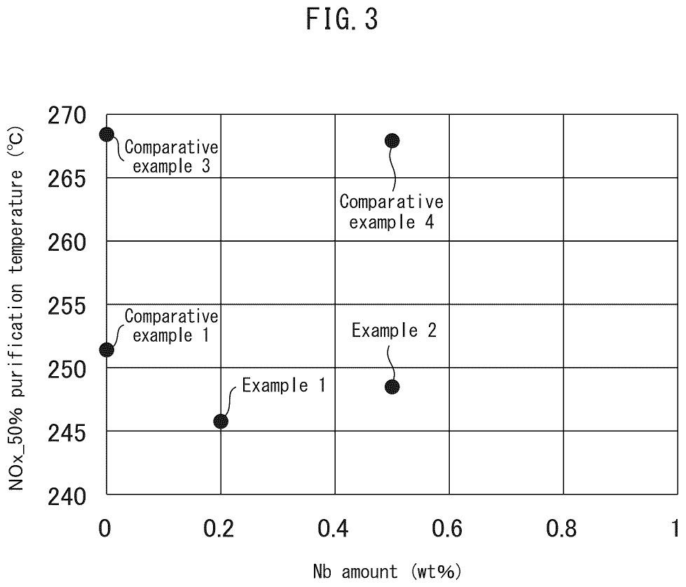

FIG. 2 is a schematic diagram of an exhaust gas purifying catalyst according to another embodiment of the present disclosure.

As shown in FIG. 2, the catalyst 2 for exhaust gas purification in accordance with another embodiment of the present disclosure is a rhodium particulate 10, a zirconium dioxide particulate 20, and a zirconium dioxide particulate 20 that is doped with a cationic having a higher number of oxide than zirconium, and a carrier particulate. The carrier particles are secondary particles in which the primary particles 40 constituting the carrier particles are aggregated. The rhodium particles 10 are supported on the zirconium dioxide particles 20. The rhodium particles 10 and the zirconium dioxide particles 20 are dispersed inside the carrier particles.

Note that FIG. 2 is not intended to limit the exhaust gas purifying catalyst of the present disclosure.

### 1-1. Rhodium Particle

In the exhaust gas purifying catalyst of the present disclosure, the rhodium particles are supported on the zirconium dioxide particles.

The size and shape of the rhodium particles may be any size and shape used as the catalyst metal of the exhaust gas purifying catalyst.

More specifically, the rhodium particles may have a median diameter (D50) of 0.1˜10.0 nm. The median diameter (D50) of the rhodium particles may be greater than or equal to 0.1 nm, greater than or equal to 1.0 nm, greater than or equal to 2.0 nm, or greater than or equal to 2.5 nm, and may be less than or equal to 10.0 nm, less than or equal to 5.0 nm, less than or equal to 3.0 nm, or less than or equal to 2.5 nm.

The median diameter (D50) can be measured, for example, by performing particle size distribution measurement using a laser diffractive particle size distribution measuring device (SALD-2300) manufactured by Shimadzu Corporation and measuring the particle size at a cumulative frequency of 50%.

The amount of the rhodium particles supported on the zirconium dioxide particles may be, for example, 0.1 to 5.0 mass % based on the entire amount of the exhaust gas purifying catalyst. The amount of the rhodium particles supported on the zirconium dioxide particles may be 0.1% by mass or more, 0.2% by mass or more, 0.3% by mass or more, or 0.4% by mass or more, and may be 5.0% by mass or less, 2.5% by mass or less, 1.0% by mass or less, or 0.5% by mass or less.

When the loading of the rhodium particles on the zirconium dioxide particles is 0.1% by mass or more, the number of the rhodium particles contributing to more NOX purification is large, and thus higher NOX purification performance can be realized. On the other hand, when the supported amount is 5.0 mass % or less, the amount of rhodium, which is an expensive noble metal, can be reduced, and the cost performance is excellent.

### 1-2. Zirconium Dioxide Particles

The zirconium dioxide particles contained in the exhaust gas purifying catalyst of the present disclosure are doped with cationics having an oxidation number higher than that of zirconium. Also, the zirconium dioxide particles can be tetragonal.

The ratio of the mass of the zirconium dioxide particles to the sum of the mass of the zirconium dioxide particles and the porous support particles can be from 1.0 to 20.0% by weight. The proportion may be 1.0% by mass or more, 5.0% by mass or more, 10.0% by mass or more, or 15.0% by mass or more, and may be 20.0% by mass or less, 15.0% by mass or less, 10.0% by mass or less, or 5.0% by mass or less. The mass of the zirconium dioxide particles is a value obtained by combining both the portion of the zirconium dioxide and the portion of the cationic in the particles.

When the ratio of the mass of the zirconium dioxide particles to the total mass of the zirconium dioxide particles and the porous carrier particles is 1.0 mass % or more, the number of zirconium dioxide particles that can act on the rhodium particles can be significantly increased. On the other hand, when the proportion is 20.0% by mass or less, the dispersibility of the zirconium dioxide particles in the pores of the porous support is particularly good.

Examples of the cationic include niobium.

The content of niobium in the zirconium dioxide particles, i.e. the mass % of the part of niobium relative to the sum of the part of zirconium dioxide and the part of niobium in the zirconium dioxide particles doped with niobium, can be from 1.0 to 7.0 mass %. The content of niobium may be 1.0 mass % or more, 1.5 mass % or more, 2.0 mass % or more, or 5.0 mass % or more, and may be 7.0 mass % or less, 6.0 mass % or less, 5.0 mass % or less, or 3.0 mass % or less.

When the content of niobium is 1.0 mass % or more, the adsorption energy of the zirconium dioxide particles is particularly large, and the evaporation of the rhodium particles is easily suppressed. On the other hand, when the content of niobium is 7.0 mass % or less, the transfer of electrons to the rhodium particles is particularly good, and 50% NOx purification temperature can be particularly reduced.

The crystallite size of the zirconium dioxide particles is preferably 6.0˜8.0 nm. The crystallite size of the zirconium dioxide particles may be greater than or equal to 6.0 nm, greater than or equal to 6.2 nm, greater than or equal to 6.4 nm, or greater than or equal to 6.8 nm, and may be less than or equal to 8.0 nm, less than or equal to 7.8 nm, less than or equal to 7.6 nm, or less than or equal to 7.4 nm.

When the crystallite diameter of the zirconium dioxide particles is equal to or larger than 6.0 nm, the effect of suppressing sintering or the like of the catalytic metallic particles is particularly good. On the other hand, when the crystallite diameter of the zirconium dioxide particles is equal to or smaller than 8.0 nm, the heat resistance of the zirconium dioxide particles is particularly good, and aggregation of the zirconium dioxide particles due to heat is particularly suppressed.

The secondary particle diameter (D50) of the zirconium dioxide particles is preferably 40 nm or less. The secondary particle size (D50) of the zirconium dioxide particles may be less than or equal to 40 nm, less than or equal to 35 nm, less than or equal to 30 nm, or less than or equal to 25 nm, and may be greater than or equal to 0 nm, greater than or equal to 5 nm, greater than or equal to 10 nm, or greater than or equal to 15 nm.

When the secondary particle diameter (D50) of the zirconium dioxide particles is such a size, the dispersibility of the zirconium dioxide particles in the pores of the porous support can be further increased.

### 1-3. Carrier Particle

The carrier included in the exhaust gas purifying catalyst of the present disclosure may be porous carrier particles used in the exhaust gas purifying catalyst. Alternatively, the carrier particles may be secondary particles in which the primary particles 40 constituting the carrier particles are aggregated. The carrier may be, for example, a metal oxide, more specifically a metal oxide containing Al, more specifically aluminum oxide (Al₂O₃), or a composite oxide containing Al and Zr, more specifically a Al₂O₃—ZrO₂ composite oxide.

The mean primary particle size (D50) of the porous carrier particles may be, for example, 1 to 1000 micrometers.

The mean primary particle size (D50) of porous carrier particles may be more than 1 μm, more than 10 μm, more than 50 μm, or more than 100 μm, not more than 1000 μm, 500 μm or less, 200 μm or less, or less than 100 μm.

The average primary particle diameter is a number average value obtained by observing at least 200 or more primary particles of porous carrier particles using a scanning electron microscope (SEM) and obtaining a circle equivalent diameter when a perfect circle equal to an area is an equal area circle, and calculating the circle equivalent diameter.

The pore size of the pores of the porous carrier particles is not particularly limited as long as the pores can support the rhodium particles and the zirconium dioxide particles in the pores. The pore diameter may be, for example, greater than or equal to 10 nm, greater than or equal to 50 nm, or greater than or equal to 100 nm, and may be less than or equal to 1000 nm, less than or equal to 500 nm, or less than or equal to 200 nm.

### 2. Method for Producing Catalyst for Purifying Exhaust Gas

The method for producing the exhaust gas purifying catalyst of the present disclosure is not particularly limited, and examples thereof include the following three methods.

### 2-1. First Manufacturing Method

A first production method for producing an exhaust gas purifying catalyst of the present disclosure includes, in this order, dispersing porous support particles, a source of zirconium dioxide, and a source of cationic in an acidic dispersion medium, and then drying and calcining to obtain porous support particles in which zirconium dioxide particles doped with cations are supported in pores, and supporting rhodium particles in zirconium dioxide particles in pores of the porous support particles. The rhodium particles are supported in the pores of the porous support particles and on the zirconium dioxide particles.

Here, as the zirconium dioxide source, for example, zirconium oxynitrate can be used. As the cation source, for example, niobium oxalate can be used. The porous carrier grains can be, for example, aluminum dioxide, i.e. Al₂O₃, and more specifically La₂O₃ complexed Al₂O₃(La₂O₃:1% by weight). As the acidic dispersion medium, for example, citric acid can be used.

The drying may be performed by evaporating the acidic dispersion medium to dryness to obtain a precipitate, and then drying in a constant-temperature oven at 100° C. to 200° C., preferably 100° C. to 150° C., more preferably 100° C. to 120° C. for 1 to 36 hours, preferably 10 to 24 hours.

The calcination may be carried out at 600° C. to 1000° C., preferably 700° C. to 900° C., more preferably 700° C. to 800° C. for 1 to 10 hours, preferably 2 to 5 hours, more preferably 3 to 4 hours, for example by atmospheric calcination.

After calcination, reduction treatment, for example, reduction treatment at 800° C. for 2 hours in a 3% hydrogen atmosphere may be performed.

pH of the dispersing medium may be, for example, 1.0 or more, 1.5 or more, or 2.0 or more, and may be 5.0 or less, 4.5 or less, or 4.0 or less. pH is particularly preferably from 2.5 to 3.5.

The method of supporting the rhodium particles on the zirconium dioxide particles in the pores of the porous carrier particles is not particularly limited, but it can be performed by adding a rhodium source, for example, rhodium nitrate, to a dispersion medium, for example, water, more specifically, distilled water, in which the porous carrier particles in which the zirconium dioxide particles are supported in the pores are dispersed, stirring, and then drying and calcining. The drying and calcination may be performed under the same conditions as the drying and calcination in obtaining the porous support particles on which the zirconium dioxide particles doped with cationics are supported in the pores.

### 2-2. Second Manufacturing Method

A second production method for producing an exhaust gas purifying catalyst of the present disclosure includes dispersing porous carrier particles in an organic solvent to obtain a first dispersion, mixing a source of zirconium dioxide and a source of cationic in the first dispersion, boiling and stirring the first dispersion, removing the organic solvent to obtain a powder, drying and calcining the powder to obtain porous carrier particles in which the zirconium dioxide particles doped with cations are supported in the pores, and supporting rhodium particles in the zirconium dioxide particles in the pores of the porous carrier particles in this order. The rhodium particles are supported in the pores of the porous support particles and on the zirconium dioxide particles.

Here, as the zirconium dioxide source, for example, zirconium butoxide can be used. As the cation source, for example, niobium butoxide can be used. The porous carrier grains can be, for example, aluminum dioxide, i.e. Al₂O₃, and more specifically La₂O₃ complexed Al₂O₃(La₂O₃:1% by weight). As the organic solvent, for example, hexane can be used.

In the second production method, the same method as that described in the first production method may be adopted for the drying and calcination, and for the loading of the rhodium particles into the zirconium dioxide particles in the pores of the porous support particles.

### 2-3. Third Manufacturing Method

A 3 method for producing an exhaust gas purifying catalyst of the present disclosure is a method for producing an exhaust gas purifying catalyst of the present disclosure. A source of zirconium dioxide, for example, zirconium oxynitrate, and a source of a cation, for example, niobium oxalate, is dispersed in a solvent, for example, water, to obtain a first dispersion, for example, by adjusting pH of the first dispersion to a base, for example, by using ammonia, to obtain a precipitate, and to obtain a first dispersion. To add a raw material of primary particles constituting the carrier particles, for example, aluminum nitrate and lanthanum nitrate, to mix, and then to remove the solvent from the first dispersion, for example, by a centrifugal separator, to obtain a first powder and a rhodium source. Dispersion and then dried and calcined to obtain a second powder, the raw material of the primary particles constituting the second powder and the carrier particles, for example Al₂O₃—CeO₂—ZrO₂ complex oxide (Al₂O₃:30% by weight/CeO₂: 20% by weight/ZrO₂: 44% by weight/Nd₂O₃: 2% by weight/La₂O₃: 2% by weight/Y₂O₃: 2 wt %), CZ complex oxide (CeO₂:51.5% by weight/ZrO₂: 45.5% by weight/Pr6O11: % by weight) and optionally a binder, such as a Al₂O₃ based binder, may be suspended to obtain a slurry, the slurry may be pressure-molded by cold isostatic pressing (CIP) or the like, and ground, and may be included in this order.

### 3. Exhaust Gas Purification Method

The exhaust gas purification method of the present disclosure includes contacting the exhaust gas with an exhaust gas purification catalyst of the present disclosure. The method of bringing the exhaust gas into contact with the exhaust gas purifying catalyst is not particularly limited.

Here, the exhaust gas may contain, for example, NOx, CO, and HC.

### Example 1

### 4. Sample Preparation

### 4-1. Example 1

Porous carrier grains (La₂O₃ compounding Al₂O₃(La₂O₃:1 wt %) were charged into hexane with stirring, and bubbling was performed with N₂ for 10 minutes to obtain dispersions. To this dispersion, zirconium butoxide and niobium butoxide were charged, and the mixture was raised to a temperature at which hexane boiled, and stirring was continued in a boiled state for 2 hours. Thereafter, the hexane was removed by a centrifuge, dried at 120° C. overnight, and calcined in air at 800° C. for 3 hours to obtain a first powder. This powder is a powder of porous carrier particles in which niobium-doped zirconium dioxide particles as cationics are supported in pores.

Rhodium nitrate and this powder were dispersed in distilled water with stirring to obtain a dispersion. The dispersion was dried and calcined to obtain a second powder. In this powder, the rhodium particles are supported in the pores of the porous support particles and supported on the zirconium dioxide particles.

A second powder, Al₂O₃—CeO₂—ZrO₂ complex oxide, CeO₂, and Al₂O₃ based binder were charged into the distilled water with stirring to prepare a suspended slurry.

The suspended slurry was dried, then pressure-molded at a pressure of 1 ton by cold isostatic pressing (CIP), and then sieved with grinding to obtain a sample of Example 1.

Here, the ratio of niobium, zirconium dioxide particles, and porous carrier particles to the total of niobium, zirconium dioxide particles, and porous carrier particles in the sample of Example 1 was, in order, niobium: 0.2 mass %, zirconium dioxide particles: 9.8 mass %, and porous carrier particles: 90.0 mass %.

### 4-2. Example 2

By adjusting the amount of zirconium butoxide and niobium butoxide, the ratio of niobium, zirconium dioxide particles, and porous carrier particles, in order, niobium: 0.5 wt %, zirconium dioxide particles: 9.5 wt %, and porous carrier particles: obtained a sample of Example 2 in the same manner as in Example 1 except that the 90.0 wt %, respectively.

### 4-3. Example 3

While stirring, zirconium oxynitrate and niobium oxalate were charged into the distilled water. pH was then adjusted to a base with ammonia to form a precipitate. A solution obtained by mixing aluminum nitrate and lanthanum nitrate in advance was further added to the solution, and then the solvent was removed by a centrifuge, dried at 120° C. overnight, and then calcined in air at 800° C. for 3 hours to obtain a desired powder.

Then, the rhodium-supported powder was prepared by charging a powder prepared with rhodium nitrate into distilled water with stirring, drying, and calcining. Then, rhodium-supported powder, Al₂O₃—CeO₂—ZrO₂ complex oxide (Al₂O₃:30 wt %/CeO₂: 20 wt %/ZrO₂: 44 wt %/Nd₂O₃: 2 wt %/La₂O₃: 2 wt %/Y₂O₃: 2 wt %), CZ complex oxide (CeO₂:51.5 wt %/ZrO₂: 45.5 wt %/Pr₆O₁₁: wt %), and Al₂O₃ based binder was charged to the distilled water while stirring, to prepare a suspended slurry. Thereafter, the sample of Example 3 was obtained by pressing at a pressure of 1 ton by cold isostatic pressing (CIP), and then sieving with grinding.

### 4-4. Comparative Example 1

A sample of Comparative Example 1 was obtained in the same manner as in Example 1 except that niobium butoxide was not used.

Here, the ratio of the zirconium dioxide particles and the porous carrier particles to the total of the zirconium dioxide particles and the porous carrier particles in the sample of Comparative Example 1 was 10.0% by mass of the zirconium dioxide particles and 90.0% by mass of the porous carrier particles, respectively.

The sample of Comparative Example 1 has no niobium.

### 4-5. Comparative Example 2

Rhodium nitrate and porous carrier particles were charged into distilled water while stirring, and dried and calcined to obtain a powder in which rhodium particles were supported on the porous carrier particles. This powder, Al₂O₃—CeO₂—ZrO₂ complex oxide, CeO₂, and Al₂O₃ based binder were charged to obtain a suspended slurry. A sample of Comparative Example 2 was obtained in the same manner as in Example 1.

The sample of Comparative Example 2 has neither niobium nor zirconium dioxide particles.

### 4-6. Comparative Example 3

A powder was obtained by adding niobium oxalate, zirconium oxynitrate, and porous carrier particles to distilled water and drying and calcining. A sample of Comparative Example 3 was obtained in the same manner as in Comparative Example 2 except that the powder was used instead of the porous carrier particles.

Here, the ratio of niobium, zirconium dioxide particles, and porous carrier particles to the total of niobium, zirconium dioxide particles, and porous carrier particles in the sample of Comparative Example 3 was, in order, niobium: 0.5 mass %, zirconium dioxide particles: 9.5 mass %, and porous carrier particles: 90.0 mass %.

In the sample of Comparative Example 3, niobium is not doped into the zirconium dioxide particles.

### 4-7. Comparative Example 4

While stirring, zirconium butoxide and niobium butoxide were added to hexane, and the mixture was raised to a temperature at which hexane boiled, and the mixture was stirred at boiling for 2 hours. Thereafter, the hexane was removed by a centrifuge, dried at 120° C. overnight, and calcined in air at 800° C. for 3 hours to obtain a first powder. This powder is a powder of zirconium dioxide particles doped with niobium.

A sample of Comparative Example 4 was obtained in the same manner as in Example 1. Here, the proportion of niobium and zirconium dioxide particles to the total of niobium and zirconium dioxide particles in the sample of Comparative Example 4 was, in order, niobium: 5 mass % and zirconium dioxide particles: 95 mass %, respectively.

Comparative Example 4 has no porous carrier particles.

### 4-8. Comparative Example 5

The first powder used in Comparative Example 4, rhodium nitrate, and porous carrier particles were charged into distilled water while stirring, and dried and calcined to obtain a powder in which rhodium particles were supported on the first powder and porous carrier particles used in Comparative Example 4. This powder, Al₂O₃—CeO₂—ZrO₂ complex oxide, CeO₂, and Al₂O₃ based binder were charged to obtain a suspended slurry. A sample of Comparative Example 5 was obtained in the same manner as in Example 1.

Here, the ratio of niobium, zirconium dioxide particles, and porous carrier particles to the total of niobium, zirconium dioxide particles, and porous carrier particles in the sample of Comparative Example 5 was, in order, niobium: 0.2 mass %, zirconium dioxide particles: 9.8 mass %, and porous carrier particles: 90.0 mass %.

In Comparative Example 5, the zirconium dioxide particles are not substantially dispersed in the pores of the porous support particles.

### 4-9. Comparative Example 6

A sample of Comparative Example 6 was obtained in the same manner as in Example 3 except that niobium oxalate was not used.

### 5. Test

### 5-1. X Beam Diffractometry

In order to identify the crystal structure of the zirconium dioxide particles in the samples of each example, an X-ray diffraction test was performed by an X-ray diffractometer. For the measurement, CuKα radiation was excited, and the scanning speed was 0.05°/min, and the range of 10-90° was measured.

And the results are shown in Table 1.

### 5-2. Durability Test

The samples of the respective examples were placed in a flow-through durability furnace and subjected to a durability test by alternately and repeatedly flowing a reducing gas (CO) and an oxidizing gas (O₂) at 1000° C. for 5 hours. The flow rate and the flow duration of the reducing gas and the oxidizing gas were distributed in 20 L/min for each 10 min.

And the results are shown in Table 1.

### 5-3. Exhaust Gas Purification Test

The samples of the respective examples after the “2-2. Durability Test” were 2 g placed in a flow-through reactor, heated to 500° C. at a heating rate of 50° C./min in a model-gas for-evaluation, held at this temperature for 10 minutes, and then cooled to 100° C.

Next, it was heated at a heating rate of 20° C./min, NOx purification performance at the time of the temperature rise was measured. Specifically, a 50% purification rate arrival temperature of NOx in the gases was calculated.

Model compositions for evaluation are CO (0.65 volume %, CO₂ (10.00 vol %), C₃H₆ (0.10 vol %), NO (0.15 volume %), O₂ (0.70 vol %), H₂ (3.00 vol %), and N₂ (residual).

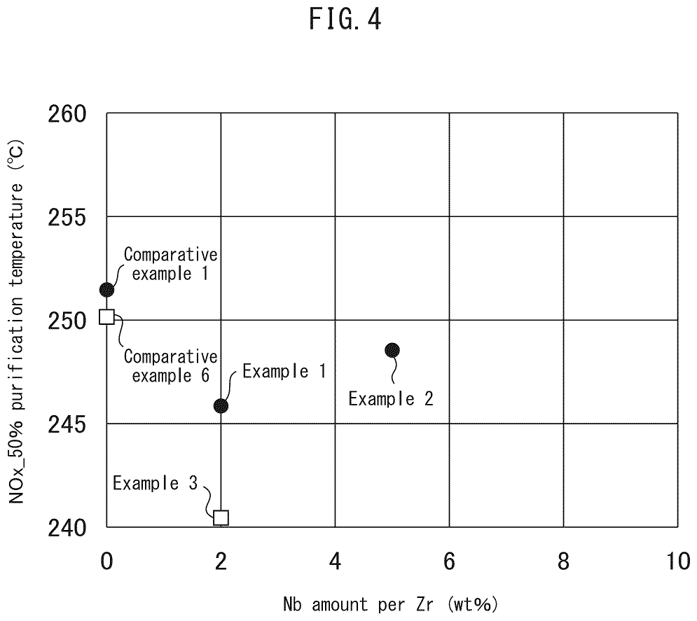

The results are shown in Table 1 and in FIGS. 3 and 4.

### 6. Results

The production conditions and test results for each example are summarized in Table 1 below. The results of the exhaust gas purification test are shown in FIGS. 3 and 4.

### [Table 1]

### 3-1. X Beam Diffractometry

As shown in Table 1, zirconium dioxide particles undergo a phase transition from a monoclinic structure to a tetragonal crystal by being doped with niobium. Therefore, the presence or absence of doping of the knob can be confirmed by examining the crystal structure of the zirconium dioxide particles.

As shown in Table 1, in Examples 1, 2, and 3 and Comparative Examples 4, 5, and 7, the zirconium dioxide was tetragonal. In contrast, in Comparative Examples 1 and 3, the zirconium dioxide was monoclinic. In Comparative Example 2, zirconium dioxide is not used.

### 3-2. Durability Test

As shown in Table 1, in Examples 1 and 2 in which the zirconium dioxide was doped with niobium particles and the zirconium dioxide particles were supported in the pores of the porous support particles, the specific surface area after the durability test was 89.0 6 m²/g and 88.03 m²/g, respectively. On the other hand, in Comparative Example 4 in which the porous carrier particles were not included, the aggregation of the zirconium dioxide particles was not suppressed, and the specific surface area after the durability test was 2. 2 m²/g, which was significantly lower.

In Comparative Examples 1 and 3, since the zirconium dioxide particles were supported in the pores of the porous carrier particles in the same manner as in Examples 1 and 2, the specific surface area after the durability test is the same value as in Examples 1 and 2. In Comparative Example 2, since the zirconium dioxide particles are not present, the specific surface area in the pores of the porous support particles is larger than in Examples 1 and 2, and therefore the specific surface area after the durability test is larger than in Examples 1 and 2. In Comparative Example 5, since the zirconium dioxide particles do not exist in the pores of the porous carrier particles, the specific surface area after the durability test is the sum of the porous carrier particles and those of the zirconium dioxide particles present outside the pores of the porous carrier particles, since the specific surface area before the durability test was large, the specific surface area after the durability test is also a large value.

In Example 3 in which the zirconium dioxide was doped with niobium particles and the zirconium dioxide particles were dispersed inside the carrier particles, the specific surface area after the durability test was 22 6 m²/g. On the other hand, in Comparative Example 6 in which niobium was not doped, the specific surface area after the durability test was 25 5 m²/g.

### 3-3. Exhaust Gas Purification Test

As shown in FIG. 3 and Table 1, in Examples 1 and 2 in which the zirconium dioxide is doped with niobium and the zirconium dioxide particles are supported in the pores of the porous carrier particles, in the exhaust gas purification test after the durability test, NOx50% purification temperature (° C.) is 245.8° C. and 248.5° C., respectively, and NOx purification rate reaches 50% at a temperature lower than the other examples.

Further, as shown in FIG. 4 and Table 1, in Example 3 in which the zirconium dioxide is doped with niobium particles and the zirconium dioxide particles are dispersed inside the carrier particles, in the exhaust gas purification test after the durability test, NOx50% purification temperature (C) is 240.4° C., and NOx purification rate reaches 50% at a temperature particularly lower than the other examples.

### EXPLANATION OF REFERENCE NUMERALS

1 and 2 Exhaust gas purifying catalyst
10 Rhodium particle
20 Zirconium dioxide particles
30 Porous carrier particles
40 Primary particle

### [Document Name]

What is claimed is:

1. An Exhaust gas purifying catalyst comprising of rhodium particles, zirconium dioxide particles doped with cationics having a higher number of oxides than zirconium, and carrier particle, wherein
the rhodium particles are supported on the zirconium dioxide particles, and
(i) the carrier particles are porous carrier particles, and the rhodium particles and the zirconium dioxide particles are supported in pores of the porous carrier particles, or
(ii) the carrier particles are composed of a plurality of primary particles, and the rhodium particles and the zirconium dioxide particles are dispersed inside the carrier particles.

2. The exhaust gas purifying catalyst according to claim 1, wherein (i) is satisfied.

3. The exhaust gas purifying catalyst according to claim 1, wherein the catalyst satisfies (ii).

4. The ratio of the mass of the zirconium dioxide particles to the total mass of the zirconium dioxide particles and the porous support particles is 1.0 to 20.0% by mass. An exhaust gas purifying catalyst according to claim 1.

5. The catalyst for exhaust gas purification according to claim 1, wherein the cation is niobium and the content of niobium in the zirconium dioxide particles is 1.0 to 7.0 mass %.
